(19) United States
(12) Patent Application Publication
(10) Pub. No.: US 2002/0143954 A1
(43) Pub. Date: Oct. 3, 2002

(54) Methods, systems and computer program products for content-based routing via active TCP connection transfer

(76) Inventors: John Andrew Aiken JR., Raleigh, NC (US); John L. Brooks, Lake Katrine, NY (US); Wesley McMillan Devine, Apex, NC (US); David Anthony Herr, Apex, NC (US); Susan M. Kimmel, Wappingers Falls, NY (US); Mark W. McClintock, Raleigh, NC (US)

Correspondence Address: Patrick J O'Shea, Samuels Gaythier & Stevens LLP, 225 Franklin Street, Suite 3300, Boston, MA, 02110, US

(21) Appl. No.: 09/825,122

(22) Filed: Apr. 3, 2001

(51) Int. Cl. G06F 15/16

(52) U.S. Cl. 709/227; 709/203

(57) ABSTRACT

Methods, systems and computer program products are provided for distributing Transport Control Protocol (TCP) connections to a specific data processing system in a cluster of data processing systems by establishing a TCP connection between a client and a first data processing system in the cluster of data processing systems. The information is obtained from the client over the TCP connection to the first data processing system. The information obtained over the TCP connection to the first data processing system is evaluated to select a target data processing system in the cluster of data processing systems for the TCP connection. The TCP connection is transferred from the first data processing system to the selected target data processing system. The transfer of the TCP connection is transparent to the client.

### FIELD OF THE INVENTION

The present invention relates to network communications and more particularly to network communications to a cluster of data processing systems.

### BACKGROUND OF THE INVENTION

As the use of the Internet has increased, in general, so has the demand placed on servers on the Internet. One technique which has been used to address this increase in demand has been through the use of multiple servers which perform substantially the same function. Applications, such as Telnet or Internet Mail Access Protocol (IMAP)/Post Office Protocol 3 (POP3) mail serving, may need to connect a Transmission Control Protocol (TCP) client to a particular TCP server of a set of similar, but not identical, servers. However, the particular server instance typically cannot be selected until after information from the client has been received. For example, an Internet Service Provider (ISP) may have multiple e-mail servers to which users may connect to obtain their mail. However, when multiple servers which perform substantially the same function are present, selecting which server a user should be connected to may present difficulties.

In the e-mail example discussed above, one conventional approach has been to have users individually configure each client application to request a connection to a dedicated server. Such may be accomplished by providing each server with a unique name or Internet Protocol address and configuring the client to specify the name or address when making a connection. Such approaches may, however, present difficulties in maintaining balanced workload between the servers as users come and go. Furthermore, reconfiguring a large population of client applications may present administrative difficulties.

Another approach to routing clients to specific servers has been through an application unique protocol between the client and the server which performs application redirection. In application redirection, a client typically establishes a first connection to a first server which sends a redirect instruction to the client. Upon receiving the redirection instruction, the client disconnects from the initial server and establishes a second connection to the specified server. One difficulty with such an approach, however, is that the client and the server typically must implement the application-unique protocol to provide the redirection and, thus, the redirection is not transparent to the client.

Another approach is known as proxying, where the client establishes an initial connection to a proxy application and the proxy application forms a second connection with the proper server after obtaining enough information from the client to select a server. Such an approach may have the advantage that the selection and communication with the selected server by the proxy may be transparent to the client. However, both inbound and outbound communications must, typically, traverse a protocol stack twice to be routed by the proxy application. First, the communications traverse the protocol stack to the proxy application and again traverse the protocol stack when routed by the proxy application. Such traversals of the protocol stack may consume significant processing resources at the server executing the proxy application.

In additional approaches, the client establishes a connection to a proxy, which in turn establishes a connection to the ultimate server. Either at a low level in the stack or by instructing an external router, a TCP connection translation function is set up which causes the router or stack to perform modification on all incoming and outgoing TCP segments. The modifications may include the server-side address (destination for incoming requests, source address for outgoing replies) in the IP header, sequence numbers in the TCP header, window sizes, and the like. Such an approach may not require traversal of the entire TCP stack, but may result in every TCP segment requiring modification, and if IP addresses flow in the application data, the connection translation function will not translate such addresses unless specifically programmed to scan all the application data. This approach also requires all flows for the connection, both inbound and outbound, to traverse a single intermediate node, making it a single point of failure (like the proxy).

Furthermore, the Locality-Aware Request Distribution system developed at Rice University is described as providing content-based request distribution which may provide the ability to employ back-end nodes that are specialized for certain types of requests. A “TCP handoff protocol” is described in which incoming requests are “handed off to a back-end in a manner transparent to a client, after the front-end has inspected the content of the request.” See Pai et al., “Locality-Aware Request Distribution in Cluster-based Network Servers”, Proceedings of the 8^{th} International Conference on Architectural Support for Programming Languages and Operating Systems, San Jose, Calif., October, 1998. See also, Aron et al., “Efficient Support for P-HTTP in Cluster-Based Web Servers”, Proceedings of the USENIX 1999 Annual Technical Conference, Monterey, Calif., June, 1999.

Other approaches to moving a client connection or session from one server to another include Virtual Telecommunications Access Method (VTAM) multi-node persistent session support. VTAM multi-node persistent session support allows for recovering a System Network Architecture (SNA) session state on another VTAM when an application fails and is restarted. However, typically, a client must re-authenticate to the applications or other system using multi-node persistent sessions. Furthermore, such a movement from a first VTAM to a second VTAM typically only occurs after a failure.

VTAM also supports CLSDEST PASS, which causes one SNA session with the client to be terminated and another initiated without disrupting the application using the sessions. Such a movement from one session to another, however, typically requires client involvement.

### SUMMARY OF THE INVENTION

Methods, systems and computer program products according to embodiments of the present invention provide for distributing Transmission Control Protocol (TCP) connections to a specific data processing system in a cluster of data processing systems by establishing a TCP connection between a client and a first data processing system in the cluster of data processing systems and obtains information through a plurality of request/response communications with the client over the TCP connection. The information obtained over the TCP connection to the first data processing system is evaluated to select a target data processing system in the cluster of data processing systems for the TCP connection. The TCP connection is transferred from the first data processing system to the selected target data processing system so that the transfer of the TCP connection is transparent to the client.

In further embodiments of the present invention, transferring the TCP connection from the first data processing system to the selected target data processing system may be accomplished by providing connection state information associated with the connection to the selected target data processing system and routing subsequent communications associated with the TCP connection to the selected target data processing system without creating a second TCP connection.

Furthermore, evaluation of the information received over the TCP connection to the first data processing system may be accomplished by providing information received over the TCP connection to an application executing on the first data processing system. The application executing on the first data processing may then evaluate the provided information to select a target instance of an application executing on a target data processing system. The transfer of the TCP connection from the first data processing system to the selected target data processing system may be provided by transferring the TCP connection to the selected target instance of the application executing on the target data processing system.

In still further embodiments of the present invention, the selected target instance of the application executing on the target data processing system may be notified of a TCP connection to be transferred to the selected target instance of the application. A confirmation of acceptance of the transfer of TCP connection may be provided by the selected target instance of the application. The TCP connection is transferred to the selected target instance of the application executing on the target data processing system if the confirmation of acceptance indicates that the selected target instance of the application accepts the transfer of the TCP connection. In particular embodiments of the present invention, the target instance of the application executing on the target data processing system may be a web server.

In still further embodiments of the present invention, the application executing on the first data processing system determines application state information based on the provided information and the selected target instance of the application. The application state information is then provided to the selected target instance of the application executing on the target data processing system. The selected target instance of the application may receive the application state information and establish a state of the target instance of the application based on the received application state information such that the transfer to the target instance of the application is transparent to the client.

Furthermore, the application executing on the first data processing system and the target instance of the application executing on the target data processing system may be instances of the same application. Alternatively, the application executing on the first data processing system may be a routing application.

Additionally, the connection may be transferred from the selected data processing system to a second selected data processing system. Thus, multiple transfers of the connection may be provided.

In particular embodiments of the present invention, the obtained information is obtained by peeking at information provided over the TCP connection, and the obtained information is provided to the selected data processing system as part of the transfer.

In additional embodiments of the present invention, methods, systems and computer program products are provided for transferring a Transmission Control Protocol (TCP) connection to a specific data processing system in a cluster of data processing systems, the cluster of data processing systems having an associated dynamically routable virtual Internet Protocol address (DVIPA). A connection utilizing the DVIPA is established between a client and a routing application utilizing a routing communication protocol stack at a first data processing system in the cluster of data processing systems. The routing application obtains information from the client over the connection to the routing application and selects a target application for transfer of the connection based on the received information. The routing communication protocol stack is notified of the selected target application and sends a connection transfer message to a target communication protocol stack associated with the selected target application. The connection transfer message contains connection state information associated with the connection to the routing application. Subsequently received communications over the connection are routed to the target communication protocol stack. The target communication protocol stack notifies the target application of the transfer of the connection to the target application and sets a state of a connection to the target application to the state specified by the connection state information associated with the connection to provide a transferred connection. The target application then communicates with the client utilizing the transferred connection.

In further embodiments of the present invention, the routing application provides application state information to the routing communication protocol stack. The application state information specifies a state of the selected target application based on the communications with the client. The routing communication protocol stack provides the application state information to the target communication protocol stack which provides the application state information to the target application. The target application resumes communications with the client from the application state specified by the provided application state information.

In additional embodiments of the present invention, the target application sends a response message to the routing application. The response message indicates whether the target application accepts or rejects the transfer of the connection. The routing application also closes a socket associated with the connection if the response message from the target application indicates that the target application accepts the transfer of the connection. The routing application may also select a second target application if the response message rejects the transfer of the connection. The routing communication protocol stack is notified of the selection of the second target application so as to initiate transfer of the connection to the second selected target application.

In still further embodiments of the present invention, the routing application sends an error message to the client over the connection if the response message indicates that the transfer of the connection is rejected.

In particular embodiments of the present invention, the routing application opens a control socket to the routing communication protocol stack so as to allow bi-directional communication between the routing communication protocol stack and the routing application. The target application may also open a control socket to the target communication protocol stack to allow bi-directional communication between the target application and the target communication protocol stack. The routing application may be identified to the routing communication protocol stack as a routing application when the routing application opens the control socket. The control sockets may be User Datagram Protocol (UDP) sockets.

The routing communication protocol stack may provide the routing application with an identification of potential target applications listening to the DVIPA utilizing the control socket. Also, the routing application may be provided with updated identifications of potential target applications listening to the DVIPA utilizing the control socket.

In still further embodiments of the present invention, the cluster of data processing system includes a plurality of communication protocol stacks and a corresponding plurality of associated applications listening to the DVIPA. In such embodiments, the plurality of communication protocol stacks may notify the routing communication protocol stack if an application is listening to the DVIPA.

In particular embodiments of the present invention, the cluster of data processing systems is a SYSPLEX cluster.

Additionally, transfer of the connection by the routing communication protocol stack may include updating a connection routing table (CRT) associated with the routing communication protocol stack to route communications to the connection to the target communication protocol stack.

As will further be appreciated by those of skill in the art, the present invention may be embodied as methods, apparatus/systems and/or computer program products.

### BRIEF DESCRIPTION OF THE DRAWINGS

FIG. 1 is block diagram of a system suitable for content-based transfer of active TCP connections according to embodiments of the present invention;

FIG. 2 is a flowchart illustrating operations for content-based transfer of active TCP connections according to embodiments of the present invention;

FIG. 3 is block diagram of a cluster of data processing systems incorporating embodiments of the present invention;

FIG. 4 is a flowchart illustrating initialization operations of protocol stacks and applications according to embodiments of the present invention; and

FIG. 5 is a flowchart illustrating operations according to further embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention can take the form of an entirely hardware embodiment, an entirely software (including firmware, resident software, micro-code, etc.) embodiment, or an embodiment containing both software and hardware aspects. Furthermore, the present invention can take the form of a computer program product on a computer-usable or computer-readable storage medium having computer-usable or computer-readable program code means embodied in the medium for use by or in connection with an instruction execution system. In the context of this document, a computer-usable or computer-readable medium can be any means that can contain, store, communicate, propagate, or transport the program for use by or in connection with the instruction execution system, apparatus, or device.

The computer-usable or computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a removable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner if necessary, and then stored in a computer memory.

Embodiments of the present invention provide for content-based transfers of an active TCP connection from one data processing system to another. Such a transfer of an active connection may be beneficial as it may allow for selection of a particular data processing system for handling a client's requested interaction without the client knowing that the transfer has taken place. Such a transfer may include transferring both application state information and connection state information. By transferring the existing active connection and application state, rather than establishing a new connection, the client need not repeat providing the initial information to the data processing system to which the connection is transferred. Furthermore, by transferring the connection to a new data processing system, rather than merely routing packets to and from the new data processing system over a separate connection, administrative overhead may be reduced and scalability may be improved.

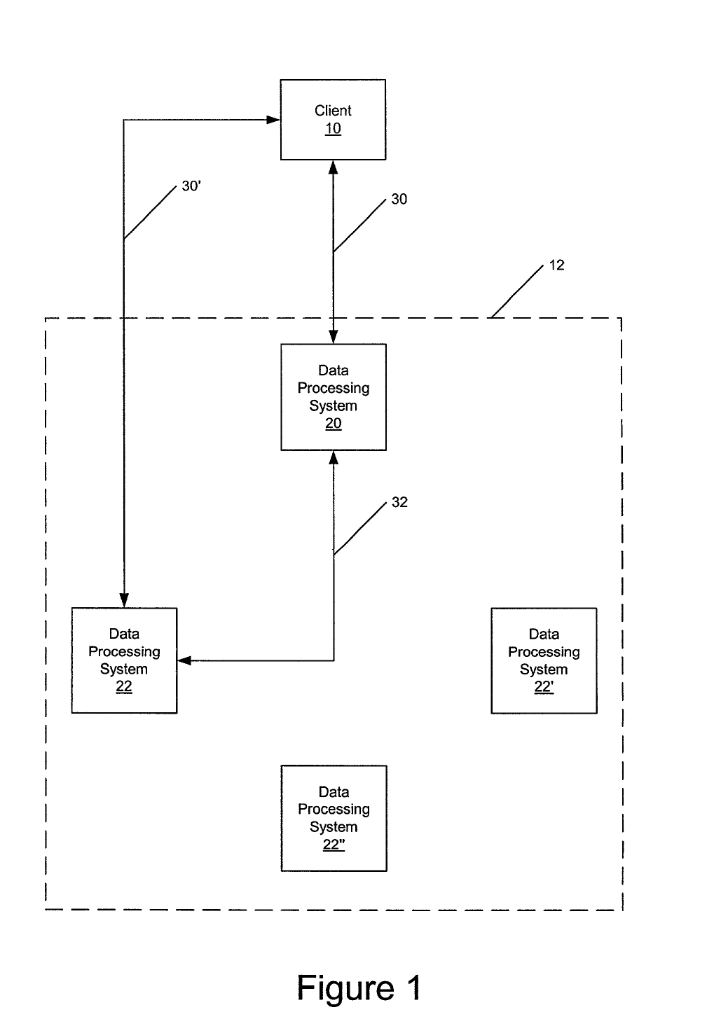

A system suitable for use in embodiments of the present invention is illustrated in FIG. 1. As seen in FIG. 1, a client 10 communicates with one or more of a plurality of data processing systems 12. The plurality of data processing systems 12 may include a first data processing system 20, which functions as a routing data processing system, and several additional data processing systems 22, 22′ and 22″. The additional data processing systems 22, 22′ and 22″ function as server data processing systems as they are executing instances of an application from which the client 10 is requesting interaction. To request interaction with the server data processing systems, the client 10 establishes an initial TCP connection 30 with the first data processing system 20 of the plurality of data processing systems 12.

The first data processing system 20 communicates with the client 10 over the initial connection 30, for example, through a plurality of request/response exchanges with the client, until such time as sufficient information is received that the first data processing system 20 can determine which of the additional data processing systems 22, 22′ and 22″ is to receive the connection with the client 10. When such a determination is made, the first data processing system 20 provides connection and/or application state information to the selected data processing system.

In the example illustrated in FIG. 1, the first data processing system 20 has selected the data processing system 22 and provides the connection and/or state information to the selected data processing system 22 over the communication path 32. The communication path 32 may be any type of communication path suitable for transferring information between the first data processing system 20 and the selected data processing system 22 and may include, for example, a TCP connection, a UDP connection or a connection through a cross-coupling facility of a SYSPLEX (and XCF connection). If accepted by the selected data processing system 22, the selected data processing system 22 continues to communicate with the client 10 over the transferred connection 30′, which is the initial connection 30 transferred to the selected data processing system 22.

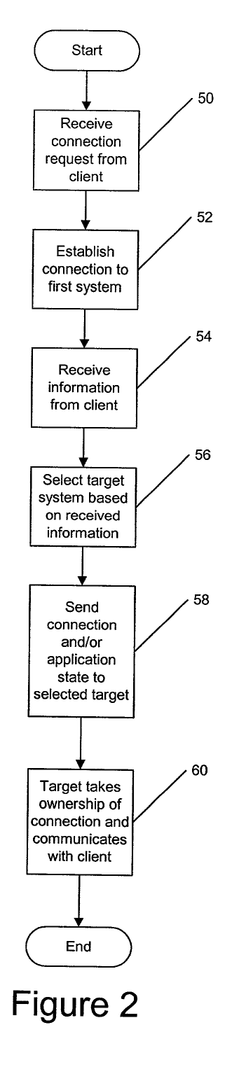

Operations for transferring an active connection are illustrated in further detail in FIG. 2. As seen in FIG. 2, the first data processing system 20 receives a connection request from the client 10 (block 50). In response to the request, the first data processing system 20 establishes the connection 30 to the client 10 (block 52). The first data processing system 20 communicates with the client 10 over the connection 30 to obtain information from the client 10 through a plurality of request/response communications until sufficient information is obtained to allow the first data processing system 20 to select one of the other data processing systems 22, 22′ and 22″ (block 54). For example, in certain embodiments of the present invention, the information may be a user name and/or password from which a mail server is selected. Similarly, the user may be authenticated as part of the selection process.

In any event, once the information is received from the client 10, the first data processing system 20 selects one of the other servers 22, 22′ and 22″ for transfer of the initial connection 30 based on the received information (block 56). Connection state information and, optionally, application state information is collected by the first data processing system 20 and provided to the selected data processing system (block 58), for example, the data processing system 22 of FIG. 1. The particular application state information may vary from application to application. The connection state information should be sufficient to allow the initial connection 30 to be transferred to the selected data processing system 22 to provide the transferred connection 30′ without disruption of the initial connection 30. For example, for a TCP connection, the state information may include the source and destination IP addresses and port numbers, the received and sent packet sequence numbers, the client and routing application advertised windows, the negotiated maximum segment size and/or scaling parameters, if any etc.

The state of the initial connection 30 may also be “frozen” until the initial connection 30 is transferred such that any subsequent packets received by the first data processing system 20 may be discarded by the first data processing system 20 so as to invoke retransmission by the client 10. Alternatively, such packets could be buffered and forwarded to the selected data processing system 22 for acknowledgment by the selected data processing system 22 over the transferred connection 30′.

After the application state and/or connection state information is provided to the selected data processing system 22, the selected data processing system 22 takes over the initial connection 30 to provide the transferred connection 30′ at the state specified by the connection state information and the application may continue from the state specified by the application state information (block 60). The selected data processing system 22 may communicate directly wit the client 10 over the transferred connection 30′ which corresponds to the initial connection 30 taken over by the selected data processing system.

As will be appreciated by those of skill in the art in light of the above discussion, from the perspective of the client, the initial connection 30 and the transferred connection 30′ are the same connection. Thus, content-based routing may be achieved and the active connection transferred to a selected data processing system in a manner which is transparent to the client 10.

In particular embodiments of the present invention systems, methods, and/or computer program products are provided which allow for a single IP address being associated with a plurality of communication protocol stacks in a cluster of data processing systems by providing a routing protocol stack which associates a Virtual IP Address (VIPA) and port with other communication protocol stacks in the cluster and routes communications to the VIPA and port to the appropriate communication protocol stack. VIPAs capable of being shared by a number of communication protocol stacks are referred to herein as “dynamic routable VIPAs” (DVIPA). While the present invention is described with reference to a specific embodiment in a System/390 Sysplex, as will be appreciated by those of skill in the art, the present invention may be utilized in other systems where clusters of computers utilize virtual addresses by associating an application or application group, rather than a particular communications adapter with the addresses. Thus, the present invention should not be construed as limited to the particular exemplary embodiments described herein.

In particular, embodiments of the present invention may be utilized in systems, such as those described in commonly assigned U.S. patent application Ser. No. 09/640,409, entitled “METHODS, SYSTEMS AND COMPUTER PROGRAM PRODUCTS FOR CLUSTER WORKLOAD DISTRIBUTION” (Attorney Docket No. 5577-205), U.S. patent application Ser. No. 09/640,438, entitled “METHODS, SYSTEMS AND COMPUTER PROGRAM PRODUCTS FOR FAILURE RECOVERY FOR ROUTED VIRTUAL INTERNET PROTOCOL ADDRESSES” (Attorney Docket No. 5577-206), U.S. patent application Ser. No. 09/640,412, entitled “METHODS, SYSTEMS AND COMPUTER PROGRAM PRODUCTS FOR NON-DISRUPTIVELY TRANSFERRING A VIRTUAL INTERNET PROTOCOL ADDRESS BETWEEN COMMUNICATION PROTOCOL STACKS” (Attorney Docket No. 5577-207), and U.S. patent application Ser. No. 09/401,419, entitled “METHODS, SYSTEMS AND COMPUTER PROGRAM PRODUCTS FOR AUTOMATED MOVEMENT OF IP ADDRESSES WITHIN A CLUSTER,” the disclosures of which are incorporated herein by reference as if set forth fully herein.

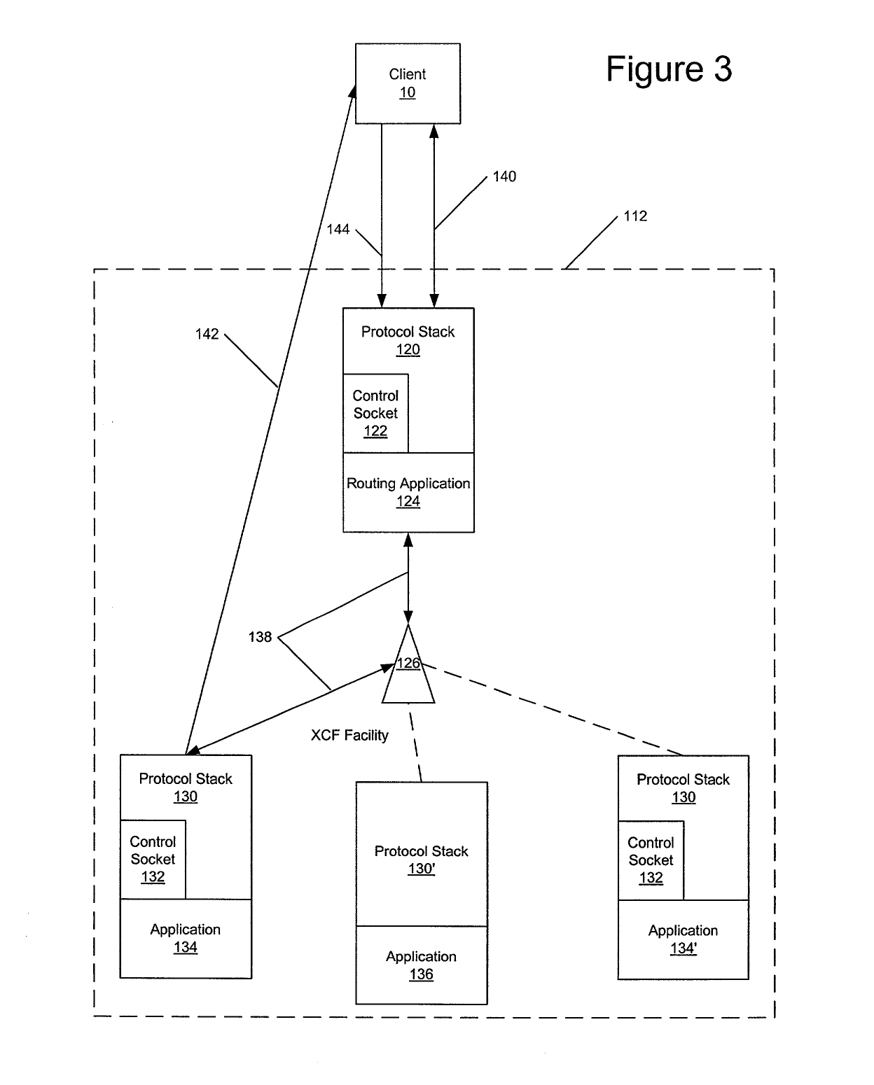

A cluster of data processing systems is illustrated in FIG. 3 as a cluster of nodes in Sysplex 112. As seen in FIG. 3, the client 10 may initially communicate with a routing protocol stack 120 which routes communications to a particular DVIPA. The DVIPA may be specified as a DVIPA for content-based routing by including in the VIPADISTRIBUTE statement of the DVIPA a configuration parameter which specifies that the DVIPA is to be content routed. For example, the configuration parameter may be “CONTENTROUTED” which would specify that connection requests to the DVIPA of the VIPADISTRIBUTE statement are to be initially routed to the routing application 124 rather than being distributed to the other data processing systems as would be the case, for example, for a conventional connection request to a DVIPA.

As is further illustrated in FIG. 3, the routing communication protocol stack 120 has associated with it a control socket 122 over which bi-directional communications between the routing communication protocol stack 120 and the routing application 124 are carried out. The control socket 122 may, for example, be a User Datagram Protocol (UDP) socket opened by the routing application 124. When the UDP socket is opened, the routing application 124 may identify itself to the routing communication protocol stack 120 such that the routing communication protocol stack 120 may associate the routing application 124 with the DVIPA.

The routing communication protocol stack 120 communicates with potential target communication protocol stacks 130, 130′ for content-based routing in the cluster 112 utilizing the cross-coupling facility (XCF) 126 and XCF messages. In embodiments of the present invention, the routing application 124 may also communicate with target applications, such as applications 134 and 134′, utilizing messages to its control socket 122 which results in XCF messages being transmitted to the potential target communication protocol stacks 130 which may provide corresponding messages to the applications 134 and 134′ through the control sockets 132.

The potential target applications 134 and 134′ may identify themselves to the communication protocol stacks 130 when the control sockets 132 are opened. The identification of the potential target applications 134 and 134′ may be provided to the routing communication protocol stack 120 as part of the DVIPA messages which are distributed throughout the cluster 112. Such an identification may, for example, identify the applications 134 and 134′ by, for example, the operating system name and/or jobname for the applications 134 and 134′. Furthermore, communications from the routing application 124 to the communication protocol stacks 130 and/or the potential target applications 134 and 134′ may be sent utilizing the dynamic XCF address of the communication protocol stacks 130.

Also illustrated in FIG. 3 is a conventional application 136 which does not utilize a control socket and communicates utilizing the communication protocol stack 130′. Because the communication protocol stack 130′ does not have a control socket, the communication protocol stack 130′ may be a potential target for a conventional DVIPA or may be a potential target for a content-based routing DVIPA which does not require application state information to be passed to the application 136.

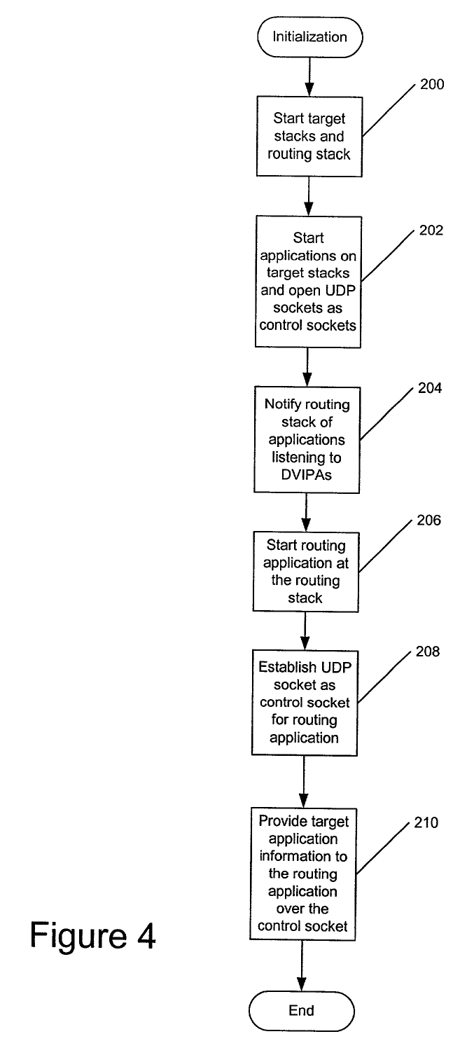

Operations for the initialization of the communication protocol stacks and applications according to embodiments of the present invention are illustrated in FIG. 4. As seen in FIG. 4, the target communication protocol stacks 130 and 130′ are started and the routing communication protocol stack 120 is also started (block 200). The potential target applications 134, 134′ and 136 are also started and, if the application is to receive application state information, a UDP socket is opened on the communication protocol stack 130 and the application identified to the communication protocol stack 130 (block 202). The target communication protocol stack 130 may, however, block accepts to the listening socket of the potential target applications 134 and 134′ until a connection is transferred to the applications.

The routing communication protocol stack 120 is notified of the applications which are listening on the DVIPA which is defined as supporting content-based routing (block 204). Such notification may be carried out by distributing the information between the communication protocol stacks 120, 130 and 130′, for example, using the XCF 126, and may include an identification of the particular application listening to the DVIPA as is described above. Content-based routing, however, will not be provided until a routing application is started and identified to the routing protocol stack 120.

The routing application 124 is also started on the routing communication protocol stack 120 (block 206). The routing application 124 establishes a UDP socket as its control socket 122 and identifies itself to the routing communication protocol stack 120 as a routing application (block 208), for example, by issuing a getibmsockopt( ), and identifying the DVIPA and port, as well as the socket to which subsequent client requests should be routed. The routing application 124 may identify itself as associated with a specific DVIPA and port or may identify its listening socket to the routing communication protocol stack 120.

Because the routing application 124 is identified as a routing application, the routing communication protocol stack 120 also provides the target application identification to the routing application 124 over the control socket 122 (block 210). Such information may be automatically provided to the routing application 124 or may be provided in response to a request from the routing application 124. However, once provided, the information may be updated as application instances are terminated or are started and bind to the communication protocol stacks in the cluster 112. Through the use of such an update, the routing communication protocol stack 120 may provide current information to the routing application 124 as the information is provided to the routing communication protocol stack 120. Such information may include Destination Port Table information which identifies communication protocol stacks having applications listening to the IP address and port of the DVIPA, as well as job names of applications listening to the IP address and port.

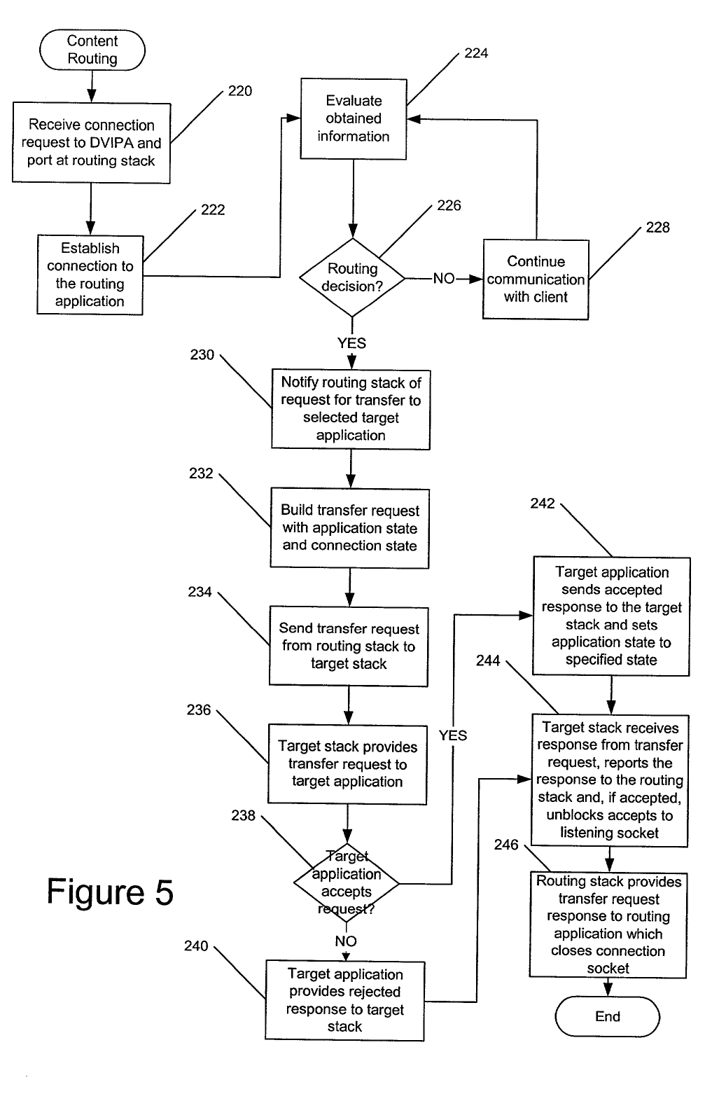

Operations for transferring an active connection will now be further described with reference to FIG. 5. As seen in the embodiments illustrated in FIG. 5, the routing communication protocol stack 120 receives a connection request at the listening socket of the routing application 124 (or applications using port sharing) or the IP address and port of the DVIPA for which content-based routing is specified (block 220). Because the connection request is to the IP address and the port of the DVIPA, the routing communication protocol stack 120 establishes a connection to the routing application 124 for the connection request (block 222).

The routing application evaluates the data from the connection request (block 224) and determines if sufficient information has been provided by the client to make a routing determination (block 226). If sufficient information has not been provided to make a routing determination (block 226), the routing application 124 continues communications with the client 10 (block 228), evaluates the provided information (block 224) and again determines if sufficient information has been received to make the routing determination (block 226). These operations continue until enough information is received from the client 10 to make the routing determination. In certain embodiments, the information provided by the client may be “peeked” at by the routing application such that the information may be evaluated without the routing application 124 “receiving” the information.

When the routing application 124 has obtained sufficient information from the client 10 to make the routing determination (block 226), the routing application 124 notifies the routing communication protocol stack 120 to request transfer of the connection to the target application (block 230). The routing communication protocol stack 120 builds a transfer request by, for example, incorporating the connection state information into a connection transfer message (block 232) and the transfer request is sent as an XCF message to the target stack (block 234).

The routing application 124 may request the transfer of the active connection to the selected target application 134 by sending the request to the routing communication protocol stack 120 over the control socket 122 (block 230). The transfer request message to the routing communication protocol stack 120 is preferably of similar format to an XCF message to the selected target communication protocol stack such that only minimal modification of the message need be carried out by the routing communication protocol stack 120 to send the message to the target application 134. Preferably, the routing application waits to request the transfer until a time when communications with the client 10 have quiesced or until the client 10 is waiting for a response. The request to transfer may include an identification of the selected target application and the application state information, if any. Furthermore, if the routing application only peeks at the information from the client, the information from the client may also be provided. Alternatively, the information could be provided after the connection is transferred.

The routing communication protocol stack 120 may reject the request if, for example, the request specifies an unknown destination for the transfer or if data is queued for transmission to the client 10. If the request to transfer the connection is accepted, the connection state may be frozen so that the connection may be resumed by the selected target application and target communication protocol stack. Such a freeze of the connection state may be accomplished, for example, by the routing communication protocol stack 120 ceasing sending acknowledgments to datagrams from the client 10. Any received datagrams may be disregarded or may be buffered and provided to the selected target application through the selected target communication protocol stack.

As described above, the application state may depend on the particular application being utilized. For example, the application state may indicate that a user has been authenticated and that the application may resume operations after the authentication. In such embodiments, the application may be viewed as distributed across the cluster 112 such that initial, common, portions of the application are carried out by the routing application 124 which then transfers operations to the selected target application, such as application 134. Alternatively, for “stateless” applications, i.e. applications which always assume a predefined state for all operations, such as a conventional web server which serves web pages in response to Hypertext Transport Protocol (HTTP) requests, the routing application 124 may merely transfer control of the connection to the target communication protocol stack and the target application. In such embodiments, application state information need not be provided to the target application.

Returning to FIG. 5, the routing communication protocol stack sends the transfer request message to the communication protocol stack associated with the selected target application 134 (block 234). As described above, the transfer request message may be sent as an XCF message which specifies the selected target application as the destination, by including, for example, the dynamic XCF address of the communication protocol stack associated with the selected target application 134 and the jobname of the selected target application 134 in the XCF message.

The target communication protocol stack 130 receives the transfer request message, removes the connection state information from the message and provides the application state information and information sufficient to allow the selected target application 134 to associate the connection with the application state information, such as, for example, client IP address and port, to the selected target application 134 over the control socket 132 (block 236). The request may also be rejected by the target stack if, for example, the specified target application does not exist.

The target application 134 evaluates the request, for example, by evaluating the application state information and/or other information in the request, to determine if the target application 134 will accept the request (block 238). If the request is not accepted (block 238), the target application 134 provides a “rejected” response to the communication protocol stack 130 associated with the target application 134 over the control socket 132 (block 240). If the request is accepted (block 238), the target application 134 takes ownership of the connection and sets its application state to the application state specified in the received transfer request, if any. The target application 134 also provides an “accepted” response to the communication protocol stack 130 associated with the target application 134 over the control socket 132 (block 242).

The target communication protocol stack 130 receives the response from the target application 134 and, if the request is accepted, unblocks the listening port of the selected target application 134 which results in a socket being established for the connection, sets the connection state associated with the socket to the received connection state and reports the response to the routing communication protocol stack 120 (block 244). If the request is not accepted, the target communication protocol stack may discard the connection state information and report the response to the routing communication protocol stack 120. The routing communication protocol stack 120 receives the response to the transfer request and provides the response to the routing application 124 (block 246). If the response indicates that the request was accepted, the routing communication protocol stack 120 may begin routing incoming messages to the target communication protocol stack 130 in the same manner as other DVIPAs (i.e. setting an entry in the CRT so that messages to the DVIPA from the source IP address are forwarded to the selected target stack). The routing application 124 may close the socket associated with the connection when the acceptance of the transfer is received (block 246).

If the request is rejected, the routing application 124 may select a new target application or send a rejection to the client 10. As such, if the request is rejected, the routing communication protocol stack 120 may unfreeze the connection to the routing application 124 and allow further communications with the client 10. Such communication may include, for example, further communications to select a target application or error notifications. If a new target application is selected, then operations may be repeated beginning with block 232.

While the operations of FIG. 5 illustrate embodiments of the present invention which provide a “handshake” between the routing application and the target application, in alternative embodiments of the present invention, such a handshake may be omitted. In such embodiments, the operations of blocks 232, 234, 236, 238, 240, 242, 244 and 246 may be eliminated or modified such that the routing application sends the application state information, if any, and the connection state information to the target application and the target communication protocol stack which unconditionally accept the transfer of the active connection. If the routing application may select the target application based on the initial TCP data from the client, then the application state information need not be provided to the target application and the unconditional transfer may occur without the use of a control socket to provide application state information to the target application.

Additionally, if the full handshake is not utilized, the givesocket( ) and takesocket( ) functions, which conventionally only allow for transfers of ownership of sockets between applications on a single TCP stack, could be modified to allow for transfers across TCP stacks in a cluster. The givesocket( )/takesocket( ) may be modified to provide a giveconnection( ) and takeconnection( ) function where, in addition to the client identification, for giveconnection( ) and takeconnection( ) reserved fields may be modified to specify the target stack and MVS image by name. Giveconnection( ) can be expanded to include an optional “application state” data field which may include application state data or a pointer to an application state data block. The contents of the application state field may be passed to the target application on its control socket, along with the client identification of the “giving” application. Logical File Support (LFS) for takeconnection( ) may be required to create a new vnode and socket on the receiving stack, and an internal Input Output Control (IOCTL) function may be defined for the LFS to notify the stack of the taking application socket.

Furthermore while embodiments of the present invention have been described with reference to transfer of active connections between a first system and a second system, as will be appreciated by those of skill in the art in light of the present disclosure, the active connection could be further transferred from the second system to a third system. Thus, for example, particular functions or operations of an application could be distributed across multiple data processing systems where the data processing systems transferred the active connection to the next data processing system upon completion of the function or operation assigned to the data processing system. Thus, the present invention should not be construed as limited to a single transfer of an active connection but may include multiple transfers.

With regard to error recovery, error recovery may be provided by the recovery mechanism described in the above-referenced United States Patent Applications. However, if a routing application is started on a backup protocol stack, the listening port of the routing application should be blocked until the backup protocol stack becomes a primary protocol stack.

Embodiments of the present invention have been described with reference to FIGS. 1 through 5 which are block diagrams and/or flowchart illustrations. It will be understood that each block of the flowchart illustrations and/or block diagrams, and combinations of blocks in the flowchart illustrations and/or block diagrams, can be implemented by computer program instructions. These program instructions may be provided to a processor to produce a machine, such that the instructions which execute on the processor create means for implementing the functions specified in the flowchart and/or block diagram block or blocks. The computer program instructions may be executed by a processor to cause a series of operational steps to be performed by the processor to produce a computer implemented process such that the instructions which execute on the processor provide steps for implementing the functions specified in the flowchart and/or block diagram block or blocks.

Accordingly, blocks of the flowchart illustrations and/or block diagrams support combinations of means for performing the specified functions, combinations of steps for performing the specified functions and program instruction means for performing the specified functions. It will also be understood that each block of the flowchart illustrations and/or block diagrams, and combinations of blocks in the flowchart illustrations and/or block diagrams, can be implemented by special purpose hardware-based systems which perform the specified functions or steps, or combinations of special purpose hardware and computer instructions.

While the present invention has been described with respect to the content-based routing function as a part of the communication protocol stack, as will be appreciated by those of skill in the art, such functions may be provided as separate functions, objects or applications which may cooperate with the communication protocol stacks. Furthermore, the present invention has been described with reference to particular sequences of operations. However, as will be appreciated by those of skill in the art, other sequences may be utilized while still benefitting from the teachings of the present invention. Thus, while the present invention is described with respect to a particular division of functions or sequences of events, such divisions or sequences are merely illustrative of particular embodiments of the present invention and the present invention should not be construed as limited to such embodiments.

Furthermore, while the present invention has been described with reference to particular embodiments of the present invention in a System/390 environment, as will be appreciated by those of skill in the art, the present invention may be embodied in other environments and should not be construed as limited to System/390 but may be incorporated into other systems, such as a Unix or other environments, by associating applications or groups of applications with an address rather than a communications adapter. Thus, the present invention may be suitable for use in any collection of data processing systems which allow sufficient communication to all of the systems for the use of dynamic virtual addressing. Accordingly, specific references to System/390 systems or facilities, such as the “coupling facility,” “ESCON,” “Sysplex” or the like should not be construed as limiting the present invention.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A method of distributing Transmission Control Protocol (TCP) connections to a specific data processing system in a cluster of data processing systems, comprising:
establishing a TCP connection between a client and a first data processing system in the cluster of data processing systems;
obtaining information from the client over the TCP connection through a plurality of request/response communications with the client over the TCP connection;
evaluating the information obtained over the TCP connection to select a target data processing system in the cluster of data processing systems for the TCP connection; and
transferring the TCP connection from the first data processing system to the selected target data processing system so that the transfer of the TCP connection is transparent to the client.

2. A method according to claim 1, wherein transferring the TCP connection from the first data processing system to the selected target data processing system comprises:
providing connection state information associated with the connection to the selected target data processing system; and
routing subsequent communications associated with the TCP connection to the selected target data processing system to transfer the TCP connection to the selected target data processing system.

3. A method according to claim 2, wherein evaluating the information obtained over the TCP connection comprises:
providing information received over the TCP connection to an application executing on the first data processing system;
wherein the application executing on the first data processing carries out the following:
evaluating the provided information to select a target instance of an application executing on a target data processing system; and
wherein transferring the TCP connection from the first data processing system to the selected target data processing system further comprises transferring the TCP connection to the selected target instance of the application executing on the target data processing system.

4. The method of claim 3, further comprising:
notifying the selected target instance of the application executing on the target data processing system of a request to transfer the TCP connection to the selected target instance of the application;
receiving a confirmation of acceptance of the transfer of the TCP connection by the selected target instance of the application; and
wherein transferring the TCP connection to the selected target instance of the application executing on the target data processing system comprises transferring the TCP connection to the selected target instance of the application executing on the target data processing system if the confirmation of acceptance indicates that the selected target instance of the application accepts the transfer of the TCP connection.

5. The method of claim 3, wherein the target instance of the application executing on the target data processing system comprises a web server.

6. The method of claim 3, wherein the application executing on the first data processing system further carries out the following:
determining application state information based on the provided information and the selected target instance of the application; and
wherein transferring the TCP connection from the first data processing system to the selected target data processing system further comprises providing the application state information to the selected target instance of the application executing on the target data processing system.

7. The method of claim 6, wherein the selected target instance of the application executing on the target data processing system carries out the following:
receiving the application state information; and
establishing a state of the target instance of the application based on the received application state information such that the transfer of the TCP connection to the target instance of the application is transparent to the client.

8. The method of claim 6, wherein the application executing on the first data processing system and the target instance of the application executing on the target data processing system are instances of the same application.

9. The method of claim 6, wherein the application executing on the first data processing system comprises a routing application.

10. The method of claim 1, further comprising transferring the TCP connection from the selected data processing system to a second selected data processing system.

11. The method of claim 1, wherein obtaining information from the client includes peeking at information provided over the TCP connection, and wherein transferring the TCP connection further comprises providing the obtained information to the selected target data processing system.

12. A method of transferring a Transmission Control Protocol (TCP) connection to a specific data processing system in a cluster of data processing systems, the cluster of data processing systems having an associated dynamically routable virtual Internet Protocol address (DVIPA), the method comprising:
establishing a connection utilizing the DVIPA between a client and a routing application utilizing a routing communication protocol stack at a first data processing system in the cluster of data processing systems;
wherein the routing application carries out the following:
obtaining information from the client over the connection to the routing application;
selecting a target application for transfer of the connection based on the obtained information; and
notifying the routing communication protocol stack of the selected target application;
wherein the routing communication protocol stack carries out the following:
sending a connection transfer message to a target communication protocol stack associated with the selected target application, the connection transfer message containing connection state information associated with the connection to the routing application; and
routing subsequent communications over the connection to the target communication protocol stack;
wherein the target communication protocol stack carries out the following:
notifying the target application of the transfer of the connection to the target application; and
setting a state of a connection to the target application to the state specified by the connection state information associated with the connection to provide a transferred connection to the target application; and
wherein the target application carries out communicating with the client utilizing the transferred connection.

13. The method of claim 12, wherein the routing application further carries out providing application state information to the routing communication protocol stack, the application state information specifying a state of the selected target application based on the information from the client;
wherein the routing communication protocol stack further carries out providing the application state information to the target communication protocol stack;
wherein the target communication protocol stack further carries out providing the application state information to the target application; and
wherein the target application further carries out resuming communications with the client from the application state specified by the provided application state information utilizing the transferred connection.

14. The method of claim 12, wherein the target application further carries out sending a response message to the routing application, the response message indicating whether the target application accepts the transfer of the connection.

15. The method of claim 14, wherein the routing application further carries out closing a socket associated with the connection if the response message from the target application indicates that the target application accepts the transfer of the connection.

16. The method of claim 14, wherein the routing application further carries out:
selecting a second target application if the response message does not accept the transfer of the connection; and
notifying the routing communication protocol stack of the selection of the second target application so as to initiate transfer of the connection to the second selected target application.

17. The method of claim 14, wherein the routing application further carries out the step of sending an error message to the client over the connection if the response message indicates that the transfer of the connection is not accepted.

18. The method of claim 12, wherein the routing application further carries out opening a control socket to the routing communication protocol stack so as to allow bi-directional communication between the routing communication protocol stack and the routing application.

19. The method of claim 18, wherein the target application further carries out opening a control socket to the target communication protocol stack to allow bi-directional communication between the target application and the target communication protocol stack.

20. The method of claim 18, wherein the routing application is identified to the routing communication protocol stack as a routing application when the routing application opens the control socket.

21. The method of claim 20, wherein the routing communication protocol stack further carries out providing the routing application with an identification of potential target applications listening to the DVIPA by utilizing the control socket.

22. The method of claim 21, wherein the routing communication protocol stack further carries out updating the routing application with identifications of potential target applications listening to the DVIPA by utilizing the control socket.

23. The method of claim 21, wherein the cluster of data processing system includes a plurality of communication protocol stacks and a corresponding plurality of associated applications listening to the DVIPA and wherein the plurality of communication protocol stacks carry out notifying the routing communication protocol stack if a corresponding application is listening to the DVIPA.

24. The method of claim 19, wherein opening a control socket comprises opening a User Datagram Protocol (UDP) socket.

25. The method of claim 12, wherein the cluster of data processing systems comprises a SYSPLEX cluster.

26. The method of claim 11, wherein the routing communication protocol stack further carries out updating a connection routing table associated with the routing communication protocol stack to route communications to the transferred connection to the target communication protocol stack.

27. The method of claim 12, wherein obtaining information from the client comprises peeking information obtained over the connection and wherein the connection transfer message further includes the obtained information.

28. A system for distributing Transmission Control Protocol (TCP) connections to a specific data processing system in a cluster of data processing systems, comprising:
means for establishing a TCP connection between a client and a first data processing system in the cluster of data processing systems;
means for obtaining information through a plurality of request/response communications with the client over the TCP connection;
means for evaluating the information obtained over the TCP connection to select a target data processing system in the cluster of data processing systems for the TCP connection; and
means for transferring the TCP connection from the first data processing system to the selected target data processing system so that the transfer of the TCP connection is transparent to the client.

29. A system for transferring a Transmission Control Protocol (TCP) connection to a specific data processing system in a cluster of data processing systems, the cluster of data processing systems having an associated dynamically routable virtual Internet Protocol address (DVIPA), comprising:
means for establishing a connection utilizing the DVIPA between a client and a routing application utilizing a routing communication protocol stack at a first data processing system in the cluster of data processing systems;
wherein the routing application comprises:
means for obtaining information from the client over the connection to the routing application;
means for selecting a target application for transfer of the connection based on the obtained information; and
means for notifying the routing communication protocol stack of the selected target application;
wherein the routing communication protocol stack comprises:
means for sending a connection transfer message to a target communication protocol stack associated with the selected target application, the connection transfer message containing connection state information associated with the connection to the routing application; and
means for routing subsequent communications over the connection to the target communication protocol stack;
wherein the target communication protocol stack comprises:
means for notifying the target application of the transfer of the connection to the target application; and
means for setting a state of a connection to the target application to the state specified by the connection state information associated with the connection to provide a transferred connection to the target application; and
wherein the target application comprises means for communicating with the client utilizing the transferred connection.

29. A computer program product for distributing Transmission Control Protocol (TCP) connections to a specific data processing system in a cluster of data processing systems, comprising:
a computer-readable storage medium having computerreadable program code embodied therein, the computerreadable program code comprising:
computer-readable program code establishes a TCP connection between a client and a first data processing system in the cluster of data processing systems;
computer-readable program code which obtains information through a plurality of request/response communications with the client over the TCP connection;
computer-readable program code which evaluates the information obtained over the TCP connection to select a target data processing system in the cluster of data processing systems for the TCP connection; and
computer-readable program code which transfers the TCP connection from the first data processing system to the selected target data processing system so that the transfer of the TCP connection is transparent to the client.

30. A computer program product for transferring a Transmission Control Protocol (TCP) connection to a specific data processing system in a cluster of data processing systems, the cluster of data processing systems having an associated dynamically routable virtual Internet Protocol address (DVIPA), comprising:
a computer-readable storage medium having computer-readable program code embodied therein, the computer-readable program code comprising:
computer-readable program code which establishes a connection utilizing the DVIPA between a client and a routing application utilizing a routing communication protocol stack at a first data processing system in the cluster of data processing systems;
wherein the routing application comprises:
computer-readable program code which obtains information from the client over the connection to the routing application;
computer-readable program code which selects a target application for transfer of the connection based on the obtained information; and
computer-readable program code which notifies the routing communication protocol stack of the selected target application;
wherein the routing communication protocol stack comprises:
computer-readable program code which sends a connection transfer message to a target communication protocol stack associated with the selected target application, the connection transfer message containing connection state information associated with the connection to the routing application; and
computer-readable program code which routes subsequent communications over the connection to the target communication protocol stack;
wherein the target communication protocol stack comprises:
computer-readable program code which notifies the target application of the transfer of the connection to the target application; and
computer-readable program code which sets a state of a connection to the target application to the state specified by the connection state information associated with the connection to provide a transferred connection to the target application; and
wherein the target application comprises computer-readable program code which communicates with the client utilizing the transferred connection.
